(19) United States
(12) Patent Application Publication
(10) Pub. No.: US 2018/0118913 A1
(43) Pub. Date: May 3, 2018

(54) CRASH PAD FOR VEHICLE AND MANUFACTURING METHOD THEREOF

(71) Applicant: HYUNDAI MOBIS CO., LTD., Seoul (KR)

(72) Inventors: Chang Wan SON, Yongin-si (KR); Hyeon Don KIM, Yongin-si (KR); Heayeon LEE, Seoul (KR)

(73) Assignee: HYUNDAI MOBIS CO., LTD., Seoul (KR)

(21) Appl. No.: 15/466,183

(22) Filed: Mar. 22, 2017

(30) Foreign Application Priority Data
Nov. 1, 2016 (KR) 10-2016-0144659

(51) Int. Cl. C08J 9/36; C08J 9/00; C09D 167/00; C08J 9/14; C09D 169/00; C08L 25/06; C08L 69/00; B29C 45/16; B29C 44/02

(52) U.S. Cl. CPC C08J 9/365; B29K 2075/00; C08J 9/0023; C09D 167/00; C08J 9/141; C09D 169/00; C08L 25/06; C08L 69/00; B29C 45/1679; B29C 44/02; C08J 2375/04; C08J 2375/06; C08J 2375/08; C08J 2203/14; C08J 9/0028

(57) ABSTRACT

The present invention relates to a crash pad for a vehicle and a manufacturing method thereof. In one embodiment, the method for manufacturing the crash pad for the vehicle comprises a step of injecting a skin foam-forming composition between a lower mold having a color coating layer formed thereon and an upper mold having a core layer formed thereon, foaming the injected skin foam-forming composition to form a skin foam layer, wherein the color coating layer is formed by applying the color coating composition to the inside surface of the lower mold and curing the applied color coating composition.

### CROSS-REFERENCE TO RELATED APPLICATION(S)

This application claims the benefit of Korean Patent Application No. 10-2016-0144659, filed on Nov. 1, 2016 in the Korean Intellectual Property Office, the entire disclosures of which are incorporated herein by reference.

### BACKGROUND OF THE INVENTION

### Field of the Invention

Exemplary embodiments of the present invention relate to a crash pad for a vehicle and a manufacturing method thereof.

### Description of the Related Art

A crash pad, also called “instrument panel”, is a vehicle interior part that is attached to the bottom of the glass in front of the driver's seat. An airbag is mounted in the crash pad. When a vehicle accident occurs, the airbag deploys through the seam of the crash pad to protect the life of the driver and the passenger from external impact. Thus, the airbag is a part that is very important in terms of design, convenience and safety.

FIG. 1 shows a conventional crash pad for a vehicle, and FIG. 2 shows the cross-section of a conventional crash pad for a vehicle. Referring to FIGS. 1 and 2, a crash pad 100 comprises a core layer 1, a foam layer 2 formed on the surface of the core layer 1, and a skin layer 3 formed on the surface of the foam layer 2. Herein, the skin layer 3 is formed of a material and a coating material, which may exhibit the appearance and sensory properties of actual leather, in order to emphasize design and sensory properties. In addition, the skin layer 3 may be subjected to a skin scoring process to form a scoring 4 for deployment of an airbag.

Meanwhile, this crash pad is manufactured by sequentially forming a skin layer and a core layer, inserting the skin layer and the core layer into a foaming mold, and foaming polyurethane in the mold to form a polyurethane foam layer. This crash pad has problems in that the production thereof is time-consuming and costly. Furthermore, the skin layer is generally formed to have a thickness of about 1 mm to 2 mm by various processes, and materials or processes used to the skin layer are costly. For this reason, methods for manufacturing crash pads having increased competitiveness as a result of reducing material costs and the number of processes have been studied.

Prior art documents related to the present invention include Korean Unexamined Patent Application No. 2015-0135708 (published on Dec. 3, 2015; entitled “Method for manufacturing a skin for a crash pad”).

### SUMMARY OF THE INVENTION

One aspect of the present invention is directed to a method for manufacturing a crash pad for a vehicle. In one embodiment, the method for manufacturing the crash pad for the vehicle includes a step of injecting a skin foam-forming composition between a lower mold having a color coating layer formed thereon and an upper mold having a core layer formed thereon, and foaming the injected skin foam-forming composition to form a skin foam layer, wherein the color coating layer is formed by applying the color coating composition to the inside surface of the lower mold and curing the applied color coating composition.

In one embodiment, the color coating composition may include a modified polyester resin, a polycarbonate diol-based resin and an additive, wherein the additive may include one or more of a pigment, a light stabilizer and a hydrolysis-preventing agent.

In another embodiment of the present invention, the color coating composition may further include a polyester elastomer.

In one embodiment, the color coating composition may be cured at a temperature between about 40° C. and about 70° C. to form the color coating layer.

In one embodiment, the lower mold having the color coating layer formed thereon may be formed by sequentially applying a release agent and the color coating composition to the inside surface of the lower mold, and curing the applied color coating composition.

In one embodiment, the skin foam-forming composition may include: a base including a polyol compound, a chain extender and a foaming agent; and an isocyanate-based curing agent.

In one embodiment, the polyol compound may include one or more of diol, triol and a polymeric polyol compound, in which the diol may include one or more of ethylene glycol, diethylene glycol, butanediol, and hexanediol, the triol may include one or more of glycerin, trimethylolpropane, and 1,2,3-hexanetriol, and the polymeric polyol compound may include one or more of a polyolefin polyol compound, a polyester polyol compound, a polycaprolactone polyol compound, a polyether polyol compound, and a polycarbonate polyol compound.

In one embodiment, the chain extender may include one or more of ethylene glycol, propylene glycol, 1,4-butanediol, glycerin, diethanolamine, and triethanolamine.

In one embodiment, the base may further include one or more of a catalyst, a pigment and a light stabilizer.

In one embodiment, the light stabilizer may include one or more of a triazine-based compound, a benzophenone-based compound and a benzotriazole-based compound.

In one embodiment, the isocyanate-based curing agent may include one or more of 4,4′-dicyclohexylmethane diisocyanate, 4,4-diphenylmethane diisocyanate, bis-4-(isocyanate chclohexyl)methane, hexamethylene diisocyanate, xylene diisocyanate, p-phenylene diisocyanate, tolidine diisocyanate, tetramethylene diisocyanate, dimethyl diisocyanate, trimethyl hexamethylene diisocyanate, phenylene diisocyanate, and dimethyl diphenyl diisocyanate.

In one embodiment, the isocyanate-based curing agent may include about 40 wt % to about 88 wt % of a monomeric methylene diphenyl diisocyanate (MDI) having a weight-average molecular weight of about 200 g/mol to about 300 g/mol, about 10 wt % to about 58 wt % of a polymeric methylene diphenyl diisocyanate (MDI) having a weight-average molecular weight of about 350 g/mol to about 600 g/mol, and about 2 wt % to about 20 wt % of a methylene diphenyl diisocyanate (MDI) prepolymer.

In one embodiment, the isocyanate-based curing agent may be included in an amount of about 35 parts by weight to about 55 parts by weight based on 100 parts by weight of the polyol compound.

In one embodiment, the core layer may be formed to have a thickness of about 1 mm to about 6 mm, the skin foam layer may be formed to have a thickness of about 3 mm to about 10 mm, and the color coating layer may be formed to have a thickness of about 10 μm to about 200 μm.

In one embodiment, the core layer may include: a matrix resin including a polycarbonate-based resin and a styrene-based resin; and an inorganic filler.

In one embodiment, the skin foam layer and the core layer may be formed without scoring.

In one embodiment, the method for manufacturing the crash pad may further include a step of releasing the crash pad having the skin foam layer formed therein from the mold, and then scoring the skin foam layer and the core layer, in which the scoring may be performed using one or more of a laser, a hot knife, a cold knife, an ultrasonic knife, and milling.

Another aspect of the present invention is directed to a crash pad for a vehicle, manufactured by the method for manufacturing the crash pad for the vehicle. In one embodiment, the crash pad for the vehicle may include: a core layer; a skin foam layer formed on the surface of the core layer; and a color coating layer formed on the surface of the skin foam layer.

In one embodiment, the core layer may have a thickness of about 1 mm to about 6 mm, the skin foam layer may have a thickness of about 3 mm to about 10 mm, and the color coating layer may have a thickness of about 10 μm to about 200 μm.

In one embodiment, the skin foam layer may be formed without scoring. In one embodiment, the skin foam layer and the core layer may be scored layers.

The crash pad for the vehicle according to the present invention is manufactured without performing conventional skin layer processes, may have excellent lightweight properties and excellent appearance and sensory properties such as tactile sensation due to a thin color coating layer formed therein, and may be highly cost-effective due to process simplification and reduced production costs.

### BRIEF DESCRIPTION OF THE DRAWINGS

FIG. 1 shows a conventional crash pad for a vehicle.

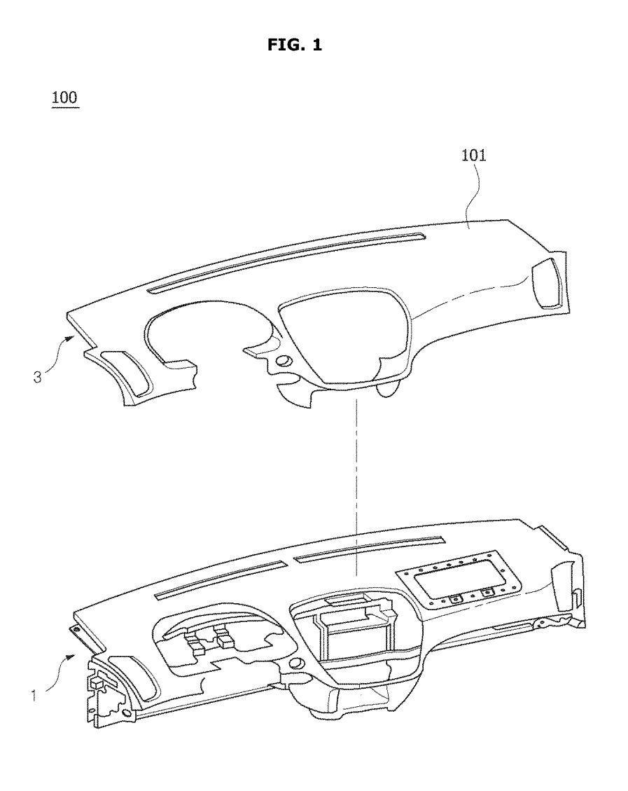

FIG. 2 shows the cross-section of a conventional crash pad for a vehicle.

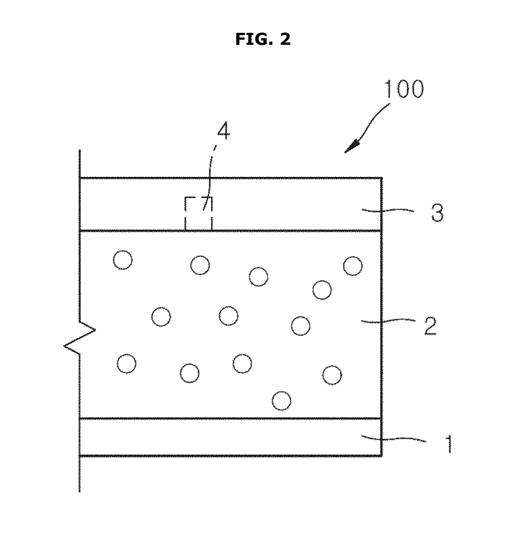

FIG. 3 shows a method for manufacturing a crash pad for a vehicle according to one embodiment of the present invention.

FIG. 4 shows the cross-section of a crash pad for a vehicle according to one embodiment of the present invention.

FIG. 5 shows photographs in which (a) is a photograph showing the cross-section of a crash pad for a vehicle, manufactured according to Example 1 of the present invention, and (b) is a photograph showing the cross-section of a crash pad for a vehicle, manufactured according to a Comparative Example for the present invention.

### DESCRIPTION OF SPECIFIC EMBODIMENTS

In the following description, the detailed description of related known technology will be omitted when it may obscure the subject matter of the present invention.

In the following description, the detailed description of related known technology or configuration will be omitted when it may obscure the subject matter of the present invention. In addition, the terms of constituent elements, which will be described hereinafter, are defined in consideration of their functions in the present invention and may be changed according to the intention of a user or an operator, or according to the custom. Accordingly, definitions of these terms must be based on the overall description herein.

Method for Manufacturing Crash Pad for Vehicle

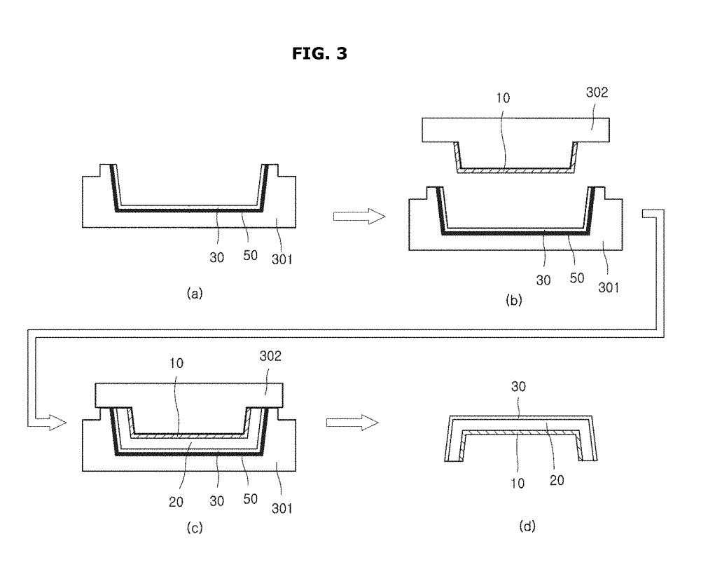

One aspect of the present invention is directed to a method for manufacturing a crash pad for a vehicle. FIG. 3 shows a method for manufacturing a crash pad for a vehicle according to one embodiment of the present invention.

Referring to FIG. 3, the method for manufacturing the crash pad for the vehicle comprises a step of injecting a skin foam-forming composition between a lower mold 301 having a color coating layer 30 formed thereon and an upper mold 302 having a core layer 10 formed thereon, foaming the injected skin foam-forming composition to form a skin foam layer 20.

Hereinafter, the method for manufacturing the crash pad for the vehicle according to the present invention will be described in detail.

Color Coating Layer

Referring to FIG. 3(a), the color coating layer 30 is formed is formed by applying a color coating composition to the lower mold 301 and curing the applied color coating composition. In one embodiment, the color coating composition may comprise a modified polyester resin, a polycarbonate diol-based resin and an additive, in which the additive may comprise a pigment, a light stabilizer and a hydrolysis-preventing agent.

Modified Polyester Resin

The modified polyester resin that is used in the present invention may include a urethane-modified polyester resin. The urethane-modified polyester resin may be prepared by a conventional method. In one embodiment, the urethane-modified polyester resin may be prepared by reacting a polyester prepolymer with an isocyanate-based curing agent. The urethane-modified polyester resin may have excellent processability and mechanical properties.

In one embodiment, the polyester prepolymer may be prepared by reacting a multifunctional alcohol compound with multifunctional carboxylic acid.

In one embodiment, the urethane-modified polyester resin may have a hydroxyl value of about 10 mg KOH/g to about 500 mg KOH/g and a weight-average molecular weight of about 1,500 g/mol to about 50,000 g/mol. Under such conditions, the urethane-modified polyester resin may have excellent workability, excellent adhesion to the color coating layer, and excellent mechanical properties.

Polycarbonate Diol-Based Resin

The polycarbonate diol-based resin may be contained for the purpose of improving the mechanical properties, heat resistance and chemical resistance of the color coating layer by forming a bond with the modified polyester resin formed in the color coating layer.

In one embodiment, the polycarbonate diol-based resin may have a weight-average molecular weight ranging from about 500 g/mol to 3000 g/mol. In this range, the color coating layer may have excellent mechanical properties, heat resistance and chemical resistance. For example, the polycarbonate diol-based resin may have a weight-average molecular weight ranging from about 800 g/mol to about 2000 g/mol.

In one embodiment, the polycarbonate diol-based resin may be contained in an amount of about 80 parts by weight to about 250 parts by weight based on 100 parts by weight of the modified polyester resin. In this content range, the molecular weight of the color coating layer may be easily increased, and the crash pad according to the present invention may have excellent mechanical properties and heat resistance. For example, the polycarbonate diol-based resin may be contained in an amount of about 80 parts by weight to about 150 parts by weight. For example, it may be contained in an amount of about 80, 90, 100, 110, 120, 130, 140, 150, 160, 170, 180, 190, 200, 210, 220, 230, 233, 240 or 250 parts by weight.

In one embodiment, the modified polyester resin and the polyester diol-based resin may be contained at a weight ratio ranging from about 1:0.5 to about 1:1.5. In this weight ratio range, the color coating composition may have excellent compatibility, and the color coating layer may have excellent texture and excellent physical properties such as tensile strength and durability.

Additive

In one embodiment, the additive may comprise a pigment, a light stabilizer and a hydrolysis-preventing agent.

Pigment

The pigment may be contained for the purpose of realizing the color of the color coating layer. In one embodiment, the pigment may comprise one or more of carbon black, titanium dioxide, iron oxide, and an organic pigment. In one embodiment, the pigment may be contained in an amount ranging from about 1 part by weight to about 25 parts by weight based on 100 parts by weight of the modified polyester resin. In this content range, the color of the color coating layer may be easily realized. For example, the pigment may be contained in an amount of about 1, 2, 3, 4, 5, 6, 7, 8, 9, 10, 11, 12, 13, 14, 15, 16, 17, 18, 19, 20, 21, 22, 23, 24 or 25 parts by weight.

Light Stabilizer

The light stabilizer may be contained for the purpose of ensuring the light resistance of the color coating layer to prevent the color of the crash pad from being changed by sunlight.

In one embodiment, the light stabilizer may comprise one or more of a triazine-based compound, a benzophenone-based compound and a benzotriazole-based compound.

In one embodiment, the triazine-based compound may comprise one or more of 2-(4,6-diphenyl-1,3,5-triazin-2-yl)-5-(hexyloxy)-phenol and 2-(4,6-bis(2,4-dimethyl-phenyl)-1,3,5-triazin-2-yl-5-octyloxy)phenol.

In one embodiment, the benzotriazole-based compound may comprise hydroxyphenyl benzotriazole. For example, it may comprise one or more of 2-(2′-hydroxy-5′-methylphenyl)benzotriazole, 2-(3′-tert-butyl-2′-hydroxy-5′-methyl-phenyl)-5-chlorobenzotriazole, 2-(3′,5′-di-tert-butyl-2′-hydroxyphenyl)-5-chlorobenzotriazole, 2-(2′-hydroxy-5′-methylphenyl)-benzotriazole, 2-(2-hydroxy-5-methylphenyl)benzotriazole, 2-(2-hydroxy-5-tert-butyl-phenyl)-5-chlorobenzotriazole, 2-(2-hydroxy-3,5-di-tert-butylphenyl)benzotriazole, 2-(2-hydroxy-5-tert-butylphenyl)benzotriazole, and 2-(2-hydroxy-4-octyloxyphenyl)-benzotriazole.

In one embodiment, the light stabilizer may be contained in an amount ranging from about 0.5 parts by weight to about 20 parts by weight based on 100 parts by weight of the modified polyester resin. In this content range, the color coating layer may have excellent light resistance while the mechanical strength thereof may be prevented from decreasing. For example, the light stabilizer may be contained in an amount of about 0.5, 1, 2, 3, 4, 5, 6, 7, 8, 9, 10, 11, 12, 13, 14, 15, 16, 17, 18, 19 or 20 parts by weight.

Hydrolysis-Preventing Agent

The hydrolysis-preventing agent may be contained for the purpose of preventing side reactions such as hydrolysis of the color coating layer.

In one embodiment, the hydrolysis-preventing agent may comprise a carbodiimide-based compound. For example, it may comprise one or more of a polycarbodiimide compound and a monocarbodiimide compound.

When the hydrolysis-preventing agent comprises the carbodiimide-based compound, side reactions such as hydrolysis of the components of the color coating composition may be prevented so that the water resistance of the color coating composition may be improved, and thus the water resistance and durability of the crash pad in a high-temperature/high-humidity environment may be improved.

In one embodiment, the polycarbodiimide compound may comprise one or more of poly(4,4′-diphenylmethane carbodiimide), poly(4,4′-dicyclohexylmethane carbodiimide), poly(1,3,5-triisopropylbenzene)polycarbodiimide, poly(1,3,5-triisopropylbenzene, and 1,5-diisopropylbenzene)polycarbodiimide. In one embodiment, the monocarbodiimide compound may comprise N,N′-di-2,6-diisopropylphenyl carbodiimide.

In one embodiment, the hydrolysis-preventing agent may be contained in an amount ranging from about 0.5 to about 20 parts by weight based on 100 parts by weight of the modified polyester resin. In this content range, the color coating layer may have excellent water resistance and durability while the mechanical strength thereof will be prevented from decreasing. For example, the hydrolysis-preventing agent may be contained in an amount of about 0.5, 1, 2, 3, 4, 5, 6, 7, 8, 9, 10, 11, 12, 13, 14, 15, 16, 17, 18, 19 or 20 parts by weight.

Polyester Elastomer

In another embodiment of the present invention, the color coating composition may further comprise a polyester elastomer. The polyester elastomer may consist of a hard segment and a soft segment. The hard segment may have an ester-type main-chain structure that forms a highly crystalline domain, and the soft segment serves as a matrix and may be a polymeric polyol consisting of a polymer of alcohols. Thus, the thermoplastic elastomer resin composition may have resistance against repeated load, impact resistance, abrasion resistance, and excellent tensile elongation and tensile strength.

In one embodiment, the hard segment may be prepared by reacting one or more of aromatic dicarboxylic acid and aromatic dicarboxylate with a polyol. In one embodiment, the aromatic dicarboxylic acid may comprise one or more of terephthalic acid (TPA), isophthalic acid (IPA), 1,5-naphthalene dicarboxylic acid (1,5-NDCA), and 2,6-naphthalene dicarboxylic acid (2,6-NDCA). In one embodiment, the aromatic dicarboxylate may comprise dimethyl isophthalate.

In one embodiment, the polyol may comprise one or more of ethylene glycol, propylene glycol, 1,4-butanediol, 1,5-pentanediol, 1,6-hexanediol, and 1,4-cyclohexanedimethanol.

In one embodiment, the soft segment may comprise a polyalkylene oxide compound. In one embodiment, the polyalkylene oxide compound may comprise one or more of polyoxyethylene glyoxypropylene glycol and polyoxytetramethylene glycol.

When the color coating composition comprises the polyester elastomer, the color coating layer may have excellent texture and durability.

In one embodiment, the polyester elastomer may be contained in an amount ranging from about 80 parts by weight to about 250 parts by weight based on 100 parts by weight of the modified polyester resin. In this content range, the color coating layer may have excellent texture and excellent mechanical properties such as tensile strength and durability. For example, the polyester elastomer may be contained in an amount of about 80, 90, 100, 110, 120, 130, 140, 150, 160, 170, 180, 190, 200, 210, 220, 230, 233, 240 or 250 parts by weight.

In another embodiment, the color coating composition that is used in the present invention may be a thermosetting polyurethane coating composition. For example, the color coating composition may be a two-component thermosetting polyurethane coating composition comprising: a base comprising a polyol compound, a chain extender and a pigment; and an isocyanate-based curing agent.

In one embodiment, the color coating layer may be formed by applying the color coating composition, and then curing the applied color coating layer at a temperature between 40° C. and 70° C. When curing is performed under this condition, the color coating layer may be easily cured, and it is possible to prevent the mold from being contaminated by dye dust occurring in the color coating layer.

In one embodiment, as shown in FIG. 3, the color coating layer is formed by applying the color coating composition to the inside surface of the lower mold 301 and curing the applied color coating composition.

In one embodiment, the color coating layer may be formed to have a thickness ranging from about 10 μm to about 200 μm. In this thickness range, the crash pad may have excellent lightweight properties and excellent sensory properties such as tactile sensation while the mechanical properties of the crash pad will not be deteriorated.

Referring to FIG. 3(a), the color coating layer 30 may be formed by sequentially applying a release agent 50 and the color coating composition to the inside surface of the lower mold 301, and then curing the applied color coating layer.

In one embodiment, the release agent may comprise one or more of zinc stearate, aluminum stearate, calcium stearate, talc powder, and silicone oil.

In one embodiment, the surface of the color coating layer may be embossed or stitched or may have a convex/concave shape. In one embodiment, in order to form a pattern on the surface of the color coating layer, the lower mold 301 may be subjected to etching or nickel electroforming.

Core Layer

A core layer 10 forms the front of the driver's seat and the passenger's seat and functions to protect the driver and the passenger from external impact when a clash or rollover accident occurs. In addition, the core layer 10 may have an insertion hole through which an airbag module is mounted, a mounting portion to which an air conditioner is attached, etc.

In one embodiment, the core layer may comprise: a matrix resin comprising a polycarbonate-based resin and a styrene-based resin; and an inorganic filler. The styrene-based resin may comprise acrylonitrile-butadiene-styrene (ABS) resin. In one embodiment, the matrix resin may comprise PC/ABS resin.

In one embodiment, the inorganic filler may comprise one or more of talc, whisker, glass fiber, carbon fiber, basalt fiber, and polymer fiber.

In one embodiment, the above-described core layer-forming composition may be kneaded, pelletized, and then injection-molded to form a core layer 10 which is then attached to the upper mold 302 as shown in FIG. 3(b).

In one embodiment, the core layer may have a thickness ranging from about 1 mm to about 6 mm. In this thickness, the core layer may have excellent impact resistance and, at the same time, may have an excellent ability to deploy an airbag when external impact is applied.

Skin Foam Layer

A skin foam layer 20 serves to ensure physical properties (such as heat resistance, impact resistance and light resistance) of the crash pad and to impart excellent sensory properties, for example, tactile sensation such as cushion feeling, to the driver and the passenger.

In one embodiment, as shown in FIG. 3(c), the skin foam layer is formed by attaching the upper mold 302 having the core layer 10 formed thereon to the lower mold 301 having the color coating layer 30 formed thereon, injecting the skin foam forming composition between the color coating layer 30 and the core layer 10, and foaming the injected skin foam forming composition.

In another embodiment, the skin foam layer may be formed by attaching the upper mold having the core layer formed thereon to the lower mold having the color coating layer formed thereon, closing the upper mold and the lower mold, injecting the skin foam forming composition between the color coating layer and the core layer through an inlet hole, and foaming the injected skin foam forming composition.

Skin Foam-Forming Composition

The skin foam-forming composition may comprise: a base comprising a polyol compound, a chain extender and a foaming agent; and an isocyanate-based curing agent.

Base

The base may comprise a polyol compound, a chain extender and a foaming agent.

Polyol Compound

In one embodiment, the polyol compound may comprise one or more of diol, triol, and polymeric polyol.

In one embodiment, the diol may comprise one or more of ethylene glycol, diethylene glycol, butanediol, and hexanediol.

In one embodiment, the triol may comprise one or more of glycerin, trimethylolpropane, and 1,2,3-hexanetriol.

In one embodiment, the polymeric polyol may comprise one or more of polyolefin polyol, polyester polyol, polycaprolactone polyol, polyether polyol, and polycarbonate polyol. For example, the polymeric polyol may comprise polyether polyol.

In one embodiment, the polyether polyol compound that is used in the present invention is prepared by polymerizing one or more compounds, selected from among ethylene glycol, 1,2-propylene glycol, 1,3-propylene glycol, butylene glycol, 1,6-hexanediol, 1,8-oxctanediol, neopentyl glycol, 2-methyl-1,3-propanediol, glycerol, trimethylolpropane, 1,2,3-hexanetriol, 1,2,4-butanetriol, trimethylolmethane, pentaerythritol, diethylene glycol, triethylene glycol, polyethylene glycol, tripropylene glycol, polypropylene glycol, dibutylene glycol, polybutylene glycol, sorbitol, sucrose, hydroquinone, resorcinol, catechol, and bisphenol, with one or more of ethylene oxide and propylene oxide.

In one embodiment, polyether polyol may be prepared to comprise a triol having a hydroxyl (OH) value of about 20 mg KOH/g to about 40 mg KOH/g and a diol having an OH value of about 20 KOH/g to about 40 mg KOH/g.

In one embodiment, the polymeric polymer may be prepared using as a base a triol having an OH value of about 20 KOH/g to about 40 mg KOH/g.

In one embodiment, the polyol compound that is used in the present invention may comprise about 75 wt % to about 90 wt % of triol (OH value: 20 mg KOH/g to 40 mg KOH/g), more than 0 wt % but not more than 15 wt % of diol (OH value: 200 mg KOH/g to 500 mg KOH/g), and more than 0 wt % but not more than 20 wt % of polymeric polyol (OH value: 20 mg KOH/g to 40 mg KOH/g).

Chain Extender

The chain extender may be contained for the purpose of extending the chain of polyurethane formed in the skin foam layer or crosslinking the polyurethane to thereby increase the molecular weight of the polyurethane and improve mechanical properties, heat resistance and chemical resistance.

In one embodiment, the chain extender may comprise one or more of diol, triol and amine compounds. For example, the chain extender may comprise one or more of ethylene glycol, propylene glycol, 1,4-butanediol, glycerin, diethanolamine (DEOA), and triethanolamine (TEOA).

In one embodiment, the chain extender may comprise two or more doils. For example, it may comprise a first diol having an OH value of about 1500 mg KOH/g to about 2500 mg KOH/g, and a second diol having an OH value of at least about 500 mg KOH/g but less than about 1500 mg KOH/g.

In one embodiment, the chain extender may contained in an amount ranging from 0.1 parts by weight to about 15 parts by weight based on 100 parts by weight of the polyol compound. In this content range, the chain extender may easily increase the molecular weight of the skin foam layer, and the crash pad of the present invention may have excellent mechanical properties and heat resistance. For example, the chain extender may contained in an amount of 0.1, 0.5, 1, 2, 3, 4, 5, 6, 7, 8, 9, 10, 11, 12, 13, 14, or 15 parts by weight.

Foaming Agent

In one embodiment, the foaming agent may comprise one or more of water, butane, n-pentane, c-pentane, hexane, heptane, chlorofluorocarbon (CFC 11), hydrogen chlorofluorocarbon (H-CFCs), hydrogen fluorocarbon (H-FCs), trichlorofluoromethane (Freon 11), chlorodifluoromethane (R-22), 1,1-dichloro-1-fluoroethane (HCFC-141b), and 1,1,1,3,3-pentafluoropropane (HFC-245fa).

In one embodiment, the foaming agent may be contained in an amount ranging from about 0.1 parts to about 15 parts by weight based on 100 parts by weight of the polyol compound. In this content range, the foaming agent may easily foam the skin foam forming composition while the mechanical properties of the skin foam layer will be prevented from decreasing. For example, the foaming agent may be contained in an amount of about 0.1, 0.5, 1, 2, 3, 4, 5, 6, 7, 8, 9, 10, 11, 12, 13, 14, or 15 parts by weight. In another embodiment, the foaming may comprise, based on 100 parts by weight of the polyol compound, about 0.1-3 parts by weight of water and about 2 parts by weight to about 10 parts by weight of n-pentane.

In one embodiment of the present invention, the base of the skin foam forming composition may further comprise one or more of a catalyst, a pigment and a light stabilizer.

Catalyst

The catalyst may be contained for the purpose of promoting the reaction between the polyol compound and isocyanate during formation of the skin foam layer and controlling a resin forming reaction and a foaming reaction in the foaming process. In one embodiment, the catalyst may further comprise an amine-based compound. For example, it may comprise one or more of triethylenediamine, pentamethyl dipropylenetriamine, and bis(2-dimethylaminoethyl)ether.

In one embodiment, the catalyst may be contained in an amount ranging from about 0.01 parts by weight to about 3 parts by weight based on 100 parts by weight of the polyol compound. In this content range, the skin foam layer may be formed with uniform density, and uniform pores may be formed. For example, the catalyst may be contained in an amount of about 0.01, 0.05, 0.1, 0.5, 1, 2 or 3 parts by weight.

Pigment

The pigment may be contained for the purpose of realizing the color of the skin foam layer. In one embodiment, the pigment may comprise one or more of carbon black, titanium dioxide, iron oxide, and an organic pigment. For example, it may comprise carbon black. In one embodiment, the pigment may be contained in an amount ranging from about 1 part by weight to about 8 parts by weight based on 100 parts by weight of the polyol compound. In this content range, the color of the skin foam layer may be easily realized. For example, the pigment may be contained in an amount of about 1, 2, 3, 4, 5, 6, 7 or 8 parts by weight.

Light Stabilizer

The light stabilizer may be contained for the purpose of ensuring the light resistance of the crash pad to prevent the color of the crash pad from being changed by sunlight.

In one embodiment, the light stabilizer may comprise one or more of triazine-, benzophenone- and benzotriazole-based compounds.

In one embodiment, the triazine-based compound may comprise one or more of 2-(4,6-diphenyl-1,3,5-triazin-2-yl)-5-(hexyloxy)-phenol and 2-(4,6-bis(2,4-dimethyl-phenyl)-1,3,5-triazin-2-yl-5-octyloxy)phenol.

In one embodiment, the benzotriazole-based compound may comprise hydroxyphenyl benzotriazole. For example, it may comprise one or more of 2-(2′-hydroxy-5′-methylphenyl)benzotriazole, 2-(3′-tert-butyl-2′-hydroxy-5′-methyl-phenyl)-5-chlorobenzotriazole, 2-(3′,5′-di-tert-butyl-2′-hydroxyphenyl)-5-chlorobenzotriazole, 2-(2′-hydroxy-5′-methylphenyl)-benzotriazole, 2-(2-hydroxy-5-methylphenyl)benzotriazole, 2-(2-hydroxy-5-tert-butyl-phenyl)-5-chlorobenzotriazole, 2-(2-hydroxy-3,5-di-tert-butylphenyl)benzotriazole, 2-(2-hydroxy-5-tert-butylphenyl)benzotriazole, and 2-(2-hydroxy-4-octyloxyphenyl)-benzotriazole.

In one embodiment, the light stabilizer may be contained in an amount ranging from about 0.5 parts by weight to about 6 parts by weight based on 100 parts by weight of the polyol compound. In this content range, the skin foam layer may have excellent light resistance while the mechanical strength of the skin foam layer may be prevented from decreasing. For example, the light stabilizer may be contained in an amount of about 0.5, 1, 2, 3, 4, 5 or 6 parts by weight.

Isocyanate-Based Curing Agent

The isocyanate-based curing agent is contained for the purpose of forming the skin foam layer by its reaction with the base.

In one embodiment, the isocyanate-based curing agent may comprise one or more of 4,4′-dicyclohexylmethane diisocyanate, 4,4-diphenylmethane diisocyanate, bis-4-(isocyanate chclohexyl)methane, hexamethylene diisocyanate, xylene diisocyanate, p-phenylene diisocyanate, tolidine diisocyanate, tetramethylene diisocyanate, dimethyl diisocyanate, trimethyl hexamethylene diisocyanate, phenylene diisocyanate, and dimethyl diphenyl diisocyanate.

For example, the isocyanate-based curing agent may comprise methylene diphenyl diisocyanate (MDI) having an isocyanate (NCO) content of about 26% to about 30%.

In one embodiment, the isocyanate-based curing agent may comprise about 40 wt % to about 88 wt % of monomeric methylene diphenyl diisocyanate (MDI) having a weight-average molecular weight of about 200 g/mol to about 300 g/mol, about 10 wt % to about 58 wt % of polymeric methylene diphenyl diisocyanate (MDI) having a weight-average molecular weight of about 350 g/mol to about 600 g/mol, and about 2 wt % to about 20 wt % of a methylene diphenyl diisocyanate (MDI) prepolymer.

In one embodiment, the methylene diphenyl diisocyanate (MDI) prepolymer may be prepared by reacting a polyol compound with an excessive amount of monomeric methylene diphenyl diisocyanate.

In this content range, the skin foam layer may have excellent tactile sensation and mechanical properties.

In one embodiment, the isocyanate-based curing agent may have a viscosity of about 50 cPs to about 250 cPs (at 25° C.) and a specific gravity of about 1.21 to about 1.23. Under such conditions, the isocyanate-based curing agent may have excellent workability and reactivity.

In one embodiment, the isocyanate-based curing agent may be contained in an amount ranging from about 35 parts by weight to about 55 parts by weight based on 100 parts by weight of the polyol compound. In this content range, the skin foam layer may have excellent tactile sensation, heat resistance and mechanical properties. For example, the isocyanate-based curing agent may be contained in an amount of about 35, 36, 37, 38, 39, 40, 41, 42, 43, 44, 45, 46, 47, 48, 49, 50, 51, 52, 53, 54 or 55 parts by weight.

In one embodiment, the skin foam layer may be formed to have a thickness ranging from about 3 mm to about 10 mm. In this thickness range, the mechanical properties and heat resistance of the skin foam layer may be ensured.

In one embodiment, the skin foam layer may be formed to have a hardness ranging from about 80 to about 90 (shore A) as measured in accordance with ASTM D 2240 standards. In this hardness range, the tactile sensation, heat resistance and mechanical properties of the skin foam layer will all be excellent. For example, the skin foam layer may be formed to have a hardness of about 80, 81, 82, 83, 84, 85, 86, 87, 88, 89 or 90 (shore A).

In the present invention, the skin foam layer may be formed without scoring. The crash pad of the present invention allows the airbag module to be easily deployed from the crash pad, even when the crash pad is not subjected to a scoring process. Furthermore, the airbag module may easily deploy from the crash pad when external impact is applied. In addition, processes for producing the crash pad may be simplified, and the production cost may be reduced. Thus, the crash pad according to the present invention may be produced with high productivity and highly cost-effective.

Scoring Process

In another embodiment of the present invention, the method may further comprise a step of releasing the crash pad 20 having the skin foam layer formed therein from the mold, and then scoring the skin foam layer and the core layer. When the scoring is formed, the scoring may be broken when external impact is applied, so that the airbag module may easily deploy from the crash pad.

In one embodiment, the scoring may be performed using one or more of a laser, a hot knife, a cold knife, an ultrasonic knife, and milling.

Crash Pad for Vehicle

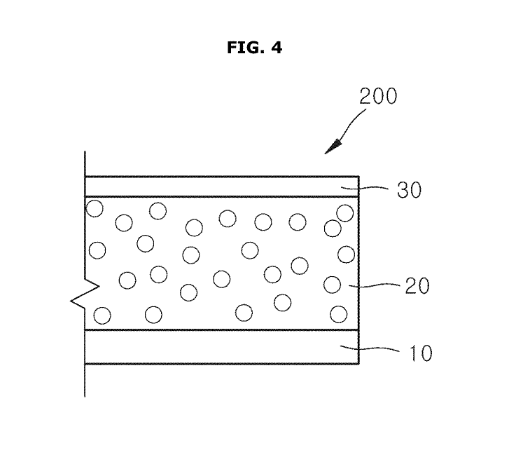

Another aspect of the present invention is directed to a crash pad for a vehicle, manufactured by the above-described method for manufacturing the crash pad for the vehicle. FIG. 4 shows the structure of a crash pad for a vehicle according to one embodiment of the present invention. Referring to FIG. 4, a crash pad 200 for a vehicle comprises: a core layer 10; a skin foam layer 20 formed on the surface of the core layer 10; and a color coating layer 30 formed on the surface of the skin foam layer 20. The core layer, the skin foam layer and the color coating layer may be formed using the same components and contents as described above, and thus the detailed description thereof is omitted.

In one embodiment, the core layer 10 may be formed to have a thickness of about 1 mm to about 6 mm, the skin foam layer 20 may be formed to have a thickness of about 3 mm to about 10 mm, and the color coating layer 30 may be formed to have a thickness of about 10 μm to about 200 μm.

In one embodiment, the skin foam layer 20 may be formed to have a hardness of about 30 to about 80 (shore C) as measured in accordance with ASTM D 2240 standards. In this thickness range, the tactile sensation, heat resistance and mechanical properties of the skin foam layer may all be excellent.

In one embodiment, the skin foam layer and the core layer may be formed without scoring. The crash pad according to the present invention may be manufactured to have a thin thickness, and thus has excellent lightweight properties. In addition, it may have an excellent ability to deploy an airbag, even when a process of scoring the skin foam layer and the core layer is not performed.

In another embodiment, the skin foam layer and the core layer may be subjected to a scoring process.

Hereinafter, preferred examples of the present invention will be described in further detail. However, these examples are for illustrative purposes only and are not intended to limit the scope of the present invention in any way.

### Example 1

(1) Color coating composition

Components used in the color coating composition are as follows.

(A) As a modified polyester resin, a urethane-modified polyester resin having a weight-average molecular weight of 3,000 g/mol to 10,000 g/mol was used.

(B) Polycarbonate diol-based resin

(B1) A polycarbonate diol-based resin having a weight-average molecular weight of 2,000 g/mol was used. (B2) A polycarbonate diol-based resin having a weight-average molecular weight of 800 g/mol was used.

(C) A polyester elastomer was used.

(D) Additive

(D1) As a light stabilizer, a triazine-based compound was used. (D2) As a hydrolysis-preventing agent, a polycarbodiimide-based compound was used.

Using the components and contents shown in Table 1, a color coating composition was prepared.

(2) Skin foam-forming composition: a skin foam-forming composition was prepared comprising: a base comprising 100 parts by weight of a polyol compound (comprising 85 wt % of triol (OH value: 35 mg KOH/g), 10 wt % of diol (OH value: 300 mg KOH/g) and 5 wt % or less of a polymeric polyol (OH value: 30 mg KOH/g)), 5 parts by weight of a chain extender (comprising a first diol having an OH value of 2000 mg KOH/g and a second diol comprising an OH value of 800 mg KOH/g), 5 parts by weight of a light stabilizer (hydroxyphenyl benzotriazole), and a foaming agent (comprising 0.5 parts by weight of water and 5 parts by weight of n-pentane); and 40 parts by weight of an isocyanate-based curing agent (comprising 60 wt % of a monomeric methylene diphenyl diisocyanate having a weight average molecular weight of 250 g/mol, 30 wt % of a polymeric methylene diisocyanate having a weight-average molecular weight of 450 g/mol, and 10 wt % of a methylene diphenyl diisocyanate prepolymer).

(3) Core layer: a core layer was prepared comprising: a matrix resin comprising a polycarbonate-based resin and a styrene-based resin; and an inorganic filler.

A release agent was applied to a lower mold, and then a color coating composition was applied (forming density: 400 kg/m³) and cured at 50° C., thereby forming a color coating layer having a thickness of 40 μm.

Next, an upper mold having a 5 mm thick core layer formed thereon was placed on the lower mold, and the skin foam forming composition was injected between the color coating layer and the core layer and foamed to form a skin foam layer having a thickness of 5 mm. Then, the resulting crash pad for a vehicle was released from the mold.

### Examples 2 to 7

Crash pads for vehicles were manufactured in the same manner as described in Example 1, except that the components and contents shown in Table 1 below were used to prepare color coating compositions.

TABLE 1

| Components | | Examples | | | | | | |
|---|---|---|---|---|---|---|---|---|
| (unit: parts by weight) | | 1 | 2 | 3 | 4 | 5 | 6 | 7 |
| (A) | | 100 | 100 | 100 | 100 | 100 | 100 | 100 |
| (B) | (B1) | — | — | — | 100 | — | — | — |
| | (B2) | — | — | — | — | 120 | — | — |
| (C) | | 100 | 233 | 233 | — | — | 100 | 100 |
| (D) | (D1) | 15 | 15 | 25 | 15 | 15 | 30 | 15 |
| | (D2) | — | — | — | — | — | — | 5 |

### Comparative Example

A crash pad was manufactured in the same manner as described in the Example, except that a 0.5 mm thick skin layer comprising an olefinic resin was formed instead of the color coating layer and that the core layer was scored to a depth of 0.3 mm by use of a hot knife.

### Test Example

(1) Measurement of tensile strength, elongation and tearing strength: for the crash pads manufactured in Examples 1 to 7, tensile strength (kgf/cm²), elongation (%) at breakage and tearing strength (kgf/cm) were evaluated. The results of the evaluation are shown in Table 2 below.

TABLE 2

| | Examples | | | | | | |
|---|---|---|---|---|---|---|---|
| | (color coating layer (forming density: 400 kg/m³)) | | | | | | |
| | 1 | 2 | 3 | 4 | 5 | 6 | 7 |
| Tensile strength | 8.8 | 8.6 | 8.9 | 8.4 | 8.2 | 8.3 | 8.2 |
| (kgf/cm²) | | | | | | | |
| Elongation (%) | 108 | 113 | 121 | 103 | 105 | 105 | 105 |
| Tearing strength | 4.3 | 4.3 | 4.5 | 4.2 | 4.1 | 4.1 | 4.2 |
| (kgf/cm) | | | | | | | |

(2) Airbag deployment test: In accordance with Hyundai Motor Company ES84500-13 (passenger airbag invisible door performance specification), a passenger airbag (PAB) module was placed in a crash pad manufactured in each of Examples 1 to 4 and the Comparative Example, and the inflator detonator was exploded by applying an electrical signal thereto at room temperature (21° C.), low temperature (−35° C.) and high temperature (85° C.). Whether or not the air bag was deployed through a seam line formed in the crash pad and whether or not crash pad pieces scattered during airbag deployment was examined, and the results were recorded as “Pass” or “Fail” in Table 3 below.

TABLE 3

| | Examples | | | | | | |
|---|---|---|---|---|---|---|---|
| | 1 | 2 | 3 | 4 | 5 | 6 | 7 |
| Airbag | Pass | Pass | Pass | Pass | Pass | Pass | Pass |
| deployment test | | | | | | | |

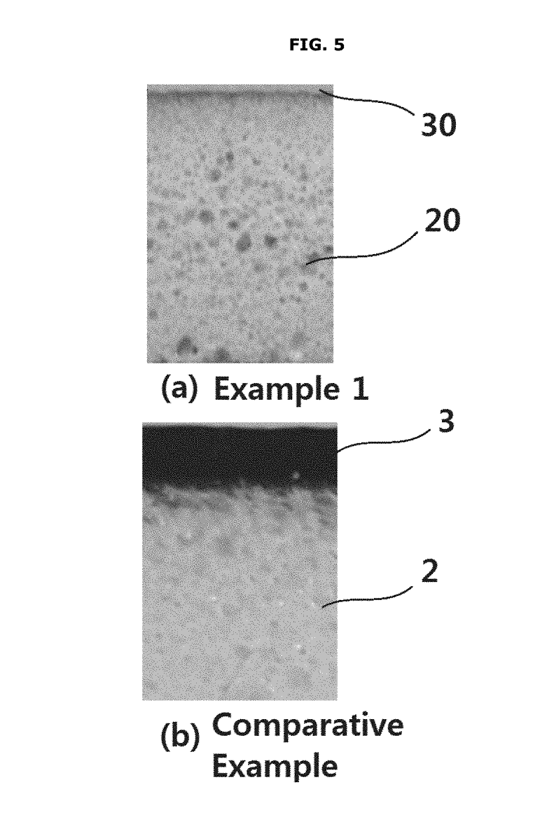

FIG. 5(a) is a photograph showing the cross-section of a crash pad for a vehicle, manufactured according to Example 1 of the present invention, and FIG. 5(b) is a photograph showing the cross-section of a crash pad for a vehicle, manufactured according to a Comparative Example for the present invention. From the results in Tables 2 and 3 above and FIG. 5, it could be seen that the crash pads of the Examples, which comprise the color coating layer, had physical properties comparable to those of the crash pad of the Comparative Example, could be manufactured by simplified processes at reduced costs such as material costs, and had a small thickness, indicating that the lightweight properties of the crash pad could be achieved. In addition, it could be seen that, because the thickness of the crash pad of the Example of the present invention was reduced, the crash pad of the Example has an excellent ability to deploy an airbag, even when the scoring process as described in the Comparative Example was not performed.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for manufacturing a crash pad for a vehicle, the method comprising a step of injecting a skin foam-forming composition between a lower mold having a color coating layer formed thereon and an upper mold having a core layer formed thereon, and foaming the injected skin foam-forming composition to form a skin foam layer,
wherein the color coating layer is formed by applying the color coating composition to an inside surface of the lower mold and curing the applied color coating composition.

2. The method of claim 1, wherein the color coating composition comprises a modified polyester resin, a polycarbonate diol-based resin and an additive,
wherein the additive comprises one or more of a pigment, a light stabilizer and a hydrolysis-preventing agent.

3. The method of claim 2, wherein the color coating composition further comprises a polyester elastomer.

4. The method of claim 1, wherein the color coating composition is cured at a temperature between about 40° C. and about 70° C. to form the color coating layer.

5. The method of claim 1, wherein the lower mold having the color coating layer formed thereon is formed by sequentially applying a release agent and the color coating composition to the inside surface of the lower mold, and curing the applied color coating composition.

6. The method of claim 1, wherein the skin foam-forming composition comprises:
a base comprising a polyol compound, a chain extender and a foaming agent; and
an isocyanate-based curing agent.

7. The method of claim 6, wherein the polyol compound comprises one or more of diol, triol and a polymeric polyol compound,
in which the diol comprised one or more of ethylene glycol, diethylene glycol, butanediol, and hexanediol,
the triol comprises one or more of glycerin, trimethylolpropane, and 1,2,3-hexanetriol, and
the polymeric polyol compound comprises one or more of a polyolefin polyol compound, a polyester polyol compound, a polycaprolactone polyol compound, a polyether polyol compound, and a polycarbonate polyol compound.

8. The method of claim 6, wherein the chain extender comprises one or more of ethylene glycol, propylene glycol, 1,4-butanediol, glycerin, diethanolamine, and triethanolamine.

9. The method of claim 6, wherein the base of the skin foam-forming composition further comprises one or more of a catalyst, a pigment and a light stabilizer.

10. The method of claim 9, wherein the light stabilizer comprises one or more of a triazine-based compound, a benzophenone-based compound and a benzotriazole-based compound.

11. The method of claim 6, wherein the isocyanate-based curing agent comprises one or more of 4,4′-dicyclohexylmethane diisocyanate, 4,4-diphenylmethane diisocyanate, bis-4-(isocyanate chclohexyl)methane, hexamethylene diisocyanate, xylene diisocyanate, p-phenylene diisocyanate, tolidine diisocyanate, tetramethylene diisocyanate, dimethyl diisocyanate, trimethyl hexamethylene diisocyanate, phenylene diisocyanate, and dimethyl diphenyl diisocyanate.

12. The method of claim 11, wherein the isocyanate-based curing agent comprises about 40 wt % to about 88 wt % of a monomeric methylene diphenyl diisocyanate (MDI) having a weight-average molecular weight of about 200 g/mol to about 300 g/mol, about 10 wt % to about 58 wt % of a polymeric methylene diphenyl diisocyanate (MDI) having a weight-average molecular weight of about 350 g/mol to about 600 g/mol, and about 2 wt % to about 20 wt % of a methylene diphenyl diisocyanate (MDI) prepolymer.

13. The method of claim 6, wherein the isocyanate-based curing agent is contained in an amount of about 35 parts by weight to about 55 parts by weight based on 100 parts by weight of the polyol compound.

14. The method of claim 1, wherein the core layer is formed to have a thickness of about 1 mm to about 6 mm,
the skin foam layer is formed to have a thickness of about 3 mm to about 10 mm, and
the color coating layer is formed to have a thickness of about 10 μm to about 200 μm.

15. The method of claim 1, wherein the core layer comprises: a matrix resin comprising a polycarbonate-based resin and a styrene-based resin; and an inorganic filler.

16. The method of claim 1, wherein the skin foam layer and the core layer are not scored.

17. The method of claim 1, further comprising a step of releasing the crash pad having the skin foam layer formed therein from the mold, and then scoring the skin foam layer and the core layer,
wherein the scoring is performed using one or more of a laser, a hot knife, a cold knife, an ultrasonic knife, and milling.

18. A crash pad for a vehicle, comprising:
a core layer;
a skin foam layer formed on a surface of the core layer; and
a color coating layer formed on a surface of the skin foam layer.

19. The crash pad of claim 18, wherein the core layer has a thickness of about 1 mm to about 6 mm,
the skin foam layer has a thickness of about 3 mm to about 10 mm, and
the color coating layer has a thickness of about 10 μm to about 200 μm.

20. The crash pad of claim 18, wherein the skin foam layer and the core layer are scored layers.
